(19) United States
(12) Patent Application Publication
(10) Pub. No.: US 2010/0252449 A1
(43) Pub. Date: Oct. 7, 2010

(54) Method for Conditioning a Cleaning Solution Resulting from the Wet Chemical Cleaning of a Nuclear Steam Generator

(75) Inventors: Rainer Gassen, Furth (DE); Christian Topf, Forchheim (DE)

Correspondence Address: LERNER GREENBERG STEMER LLP, P O BOX 2480, HOLLYWOOD, FL, 33022-2480, US

(73) Assignee: AREVA NP GMBH, Erlangen (DE)

(21) Appl. No.: 12/817,366

(22) Filed: Jun. 17, 2010

Related U.S. Application Data
(63) Continuation of application No. PCT/EP2009/053329, filed on Mar. 20, 2009.

(30) Foreign Application Priority Data
Mar. 28, 2008 (DE) 10 2008 016 020.2

(51) Int. Cl. B01D 43/00

(52) U.S. Cl. 205/771

(57) ABSTRACT

A method for conditioning a cleaning solution resulting from the wet chemical cleaning of a nuclear steam generator, includes electrolytically treating the cleaning solution and depositing radioactive metal nuclides contained in the cleaning solution on a cathode.

### CROSS-REFERENCE TO RELATED APPLICATION

This is a continuation application, under 35 U.S.C. §120, of copending International Application No. PCT/EP2009/053329, filed Mar. 20, 2009, which designated the United States; this application also claims the priority, under 35 U.S.C. §119, of German Patent Application DE 10 2008 016 020.2, filed Mar. 28, 2008; the prior applications are herewith incorporated by reference in their entirety.

### BACKGROUND OF THE INVENTION

### Field of the Invention

The invention relates to a method for conditioning a cleaning solution resulting from the wet chemical cleaning of a nuclear steam generator.

It is necessary to dispose of cleaning solutions resulting from the wet chemical cleaning of a nuclear steam generator. Complexing agents, ammonium, amines and iron are generally situated therein in dissolved form. The used cleaning solutions are incinerated as hazardous waste in many cases. However, particular problems in the disposal occur if the cleaning solutions contain radioactive metal nuclides, for example Co60, in concentrations above a permissible authorized limit. Those used cleaning solutions cannot therefore be treated as standard waste, but must be conditioned in a very complex and expensive manner for final disposal and placed in special final disposal sites.

Although it is possible in principle to load the components of the cleaning solution onto ion-exchange resins, that leads to enormous volumes of radioactively contaminated waste.

### SUMMARY OF THE INVENTION

It is accordingly an object of the invention to provide a method for conditioning a cleaning solution resulting from the wet chemical cleaning of a nuclear steam generator, which overcomes the hereinafore-mentioned disadvantages of the heretofore-known methods of this general type and with which it is also possible to economically dispose of cleaning solutions which are contaminated with radioactive metal nuclides.

With the foregoing and other objects in view there is provided, in accordance with the invention, a method for conditioning a cleaning solution resulting from the wet chemical cleaning of a nuclear steam generator, which comprises electrolytically treating the cleaning solution and depositing radioactive metal nuclides contained in the cleaning solution on a cathode. The cathode is a diamond electrode, the potential of which is set to be above the potential of hydrogen development or evolution.

Since the cleaning solution is electrolytically treated and radioactive metal nuclides contained in the cleaning solution are deposited on a cathode, it is possible to reduce the radioactive contamination of the cleaning solution to the extent that it comes under a predetermined authorized limit. In this manner, disposal of the cleaning solution present in a large amount is considerably simplified, since only the radioactively contaminated cathode needs to be disposed of as radioactive waste taking into account the respective radiation protection and final deposit conditions.

Since the cathode is a diamond electrode and accordingly is formed of a material which has a hydrogen overpotential, and the potential thereof is set to be above the potential of hydrogen development or evolution, a particularly effective deposition of radioactive metal nuclides is achieved.

If, in addition, the anode is likewise formed of a material which has an oxygen overpotential, and is preferably likewise a diamond electrode, the potential of which is set to be below the potential of oxygen development or evolution, during the electrolysis, at the same time the organic components in the cleaning solution, e.g. a complexing agent, can be denatured, and therefore virtually the entire Fe precipitates out as oxide or hydroxide. Due to the high surface area of the precipitated iron oxide or iron hydroxide, radioactive metal nuclides still present in the solution, for example Co60, are furthermore adsorbed thereto and are also removed from the cleaning solution in this manner. In the case of a sufficiently long electrolysis time, all of the complexing agent (e.g. EDTA) can be destroyed. At the same time, during this treatment the COD or TOC value (chemical oxygen demand or total content of organic carbon) markedly decreases. In this manner, it is possible to reduce the contamination not only with organic compounds but also with radioactive nuclides to the extent that the solution can be disposed of with low expenditure. Only the precipitate and the cathode then have to be disposed of as radioactive waste with a considerably lower volume.

It is not necessary to dispose of the cathode, i.e. further use thereof is possible if the metals deposited thereon are detached by using an inorganic acid. In this case, after neutralization, only the neutralized acid together with any precipitate (FeO, Fe₂O₃, Fe(OH)₂, Fe(OH)₃ formed by destroying the complexing agents still needs to be disposed of.

At a high concentration of radioactive Co60, in an advantageous configuration of the method, a two-stage electrolysis is carried out in which the cleaning solution, after a first electrolytic treatment, is acidified and then subjected to a second electrolytic treatment. In other words: first the cleaning solution is electrolyzed without pretreatment. In this manner, the dissolved Fe is deposited and, when an anode having an oxygen overpotential is used, in addition precipitated out. After it is filtered off, the cleaning solution pretreated in this manner is acidified and again electrolyzed until the concentration of activity (Co60) is below a predetermined authorized limit. Thereafter, the cleaning solution can be neutralized and disposed of.

Other features which are considered as characteristic for the invention are set forth in the appended claims.

Although the invention is illustrated and described herein as embodied in a method for conditioning a cleaning solution resulting from the wet chemical cleaning of a nuclear steam generator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1 and 2 are diagrams respectively showing a fraction in which iron Fe and cobalt Co are present in a cleaning solution, on an electrode and in a precipitate after single-stage and two-stage electrolysis.

### DETAILED DESCRIPTION OF THE INVENTION

Referring now to the figures of the drawings and the examples in detail and first, particularly, to Example 1 thereof, there is seen the following:

### Example 1

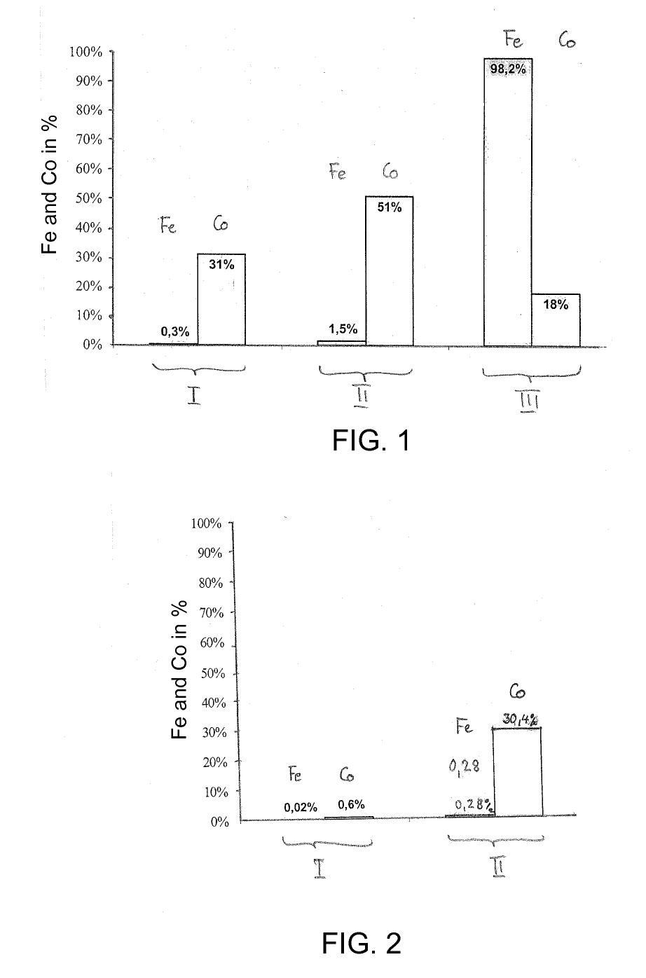

A simulated steam generator-cleaning solution (1.3 l) containing 10 g/l of EDTA, 11.8 g/l of morpholine, equivalent to a COD value of 29.2 g/l, 106 mg/l of Co and 2.1 g/l of Fe was electrolyzed at diamond electrodes (cathode and anode). After 6 h at 1.0 A/m² the cleaning solution (graphically reproduced by a bar I in the diagram of FIG. 1) only contained 0.3% of the Fe and 31% of the Co. On the cathode (illustrated by a bar II in the diagram of FIG. 1), 1.5% of the Fe and 51% of the Co were deposited. 98.2% of the Fe and 18% of the Co were adsorbed in the precipitate (illustrated by the bar III in the diagram of FIG. 1). The EDTA was 96% destroyed, and the COD value was reduced by about 50%.

The cleaning solution treated in this manner was filtered, the filtrate acidified (pH≈2) and, in a subsequent treatment step, electrolyzed again for 8 h at 2.0 A/m². Of the 6.3 mg/l of Fe remaining in the solution, 6.0 mg/l were deposited on the cathode and therefore only 0.28% of the dissolved Fe originally in the cleaning solution was still present on the cathode (graphically reproduced in the diagram of FIG. 2 by a bar II) and only 0.4 mg/l or 0.02% in the solution (graphically reproduced in the diagram of FIG. 2 by a bar I). Of the remaining Co (33 mg/l or 31%), 32.4 mg/l, or 30.4%, of the Co originally dissolved was deposited on the cathode (see the bar II) and thus only 0.6 ppm or 0.6% of the originally dissolved Co was still present in the cleaning solution (see the bar I).

As soon as after a treatment time of 2 h in the second treatment step, the final values of the respective EDTA content and COD value of 0.01 g/l and 0.16 g/l were reached. Not only the content of EDTA but also the COD value, were reduced by over 99% through the combined treatment.

### Example 2

A simulated cleaning solution (1.3 l) containing 10 g/l of EDTA, 11.8 g/l of morpholine, equivalent to a COD value of 29.2 g/l, 63 mg/l of Co and 1.96 g/l of Fe was acidified in a first step to a pH of approximately 2 and electrolyzed for 8 h at 2000 A/m². After the acid electrolysis was terminated, 92% of the originally dissolved Co and 89% of the originally dissolved Fe were deposited. In the solution 5 mg/l of Co and 0.22 g/l of Fe were still present. The COD content in the solution was only 0.29 g/l, and the EDTA content in the solution was reduced to 0.25 g/l.

In the case of a radioactive contamination, the Fe and Co deposited on the cathode are detached using an acid, e.g. sulfuric acid, and the solution is subsequently neutralized and vaporized. Otherwise, Fe and Co can be detached anodically after a preceding acidification. The resultant solution can then be neutralized with NH₃ and subsequently likewise vaporized.

The advantage of such an acid single-stage electrolysis according to Example 2 is basically that the filtration and repeated electrolysis stages that are required in Example 1 are omitted.

1. A method for conditioning a cleaning solution resulting from the wet chemical cleaning of a nuclear steam generator, the method comprising the following steps:
electrolytically treating the cleaning solution;
depositing radioactive metal nuclides contained in the cleaning solution on a cathode;
providing a diamond electrode as the cathode; and
setting a potential of the diamond electrode to be above a potential of hydrogen evolution.

2. The method according to claim 1, which further comprises detaching the metals deposited on the cathode by using an acid.

3. The method according to claim 1, which further comprises acidifying and subsequently again electrolytically treating the cleaning solution after the electrolytic treating step.

4. The method according to claim 1, which further comprises forming the anode of a material having an oxygen overpotential, and setting a potential of the anode to be below the potential of oxygen evolution.

5. The method according to claim 4, which further comprises forming the anode as a diamond electrode.
